(19) United States
(12) Patent Application Publication
(10) Pub. No.: US 2013/0201734 A1
(43) Pub. Date: Aug. 8, 2013

(54) DEVICE FOR SUPPRESSING HIGH-FREQUENCY CURRENTS IN INFEED LINES OF AN INVERTER

(71) Applicants: Lorenz Jung, Nurnberg (DE); Robert Schmid, Neunkirchen am Brand (DE); Thomas Schröck, Erlangen (DE); Gerhard Zimmer, Erlangen (DE)

(72) Inventors: Lorenz Jung, Nurnberg (DE); Robert Schmid, Neunkirchen am Brand (DE); Thomas Schröck, Erlangen (DE); Gerhard Zimmer, Erlangen (DE)

(73) Assignee: SIEMENS AKTIENGESELLSCHAFT, MUENCHEN (DE)

(21) Appl. No.: 13/820,556

(22) PCT Filed: Aug. 19, 2011
(86) PCT No.: PCT/EP2011/064269

§ 371 Date: Mar. 25, 2013

(30) Foreign Application Priority Data
Sep. 2, 2010 (DE) 10 2010 044 621.1

(51) Int. Cl. H02M 1/12

(52) U.S. Cl. CPC H02M 1/12
USPC 363/39

(57) ABSTRACT

A device for suppressing high-frequency currents in infeed lines to an inverter having a common-mode impedance. A magnetic core is configured for inductively coupling the infeed lines, wherein the current load on the common-mode impedance is minimized. A snubber impedance unit is inductively coupled to the common-mode impedance and has a frequency-dependent impedance.

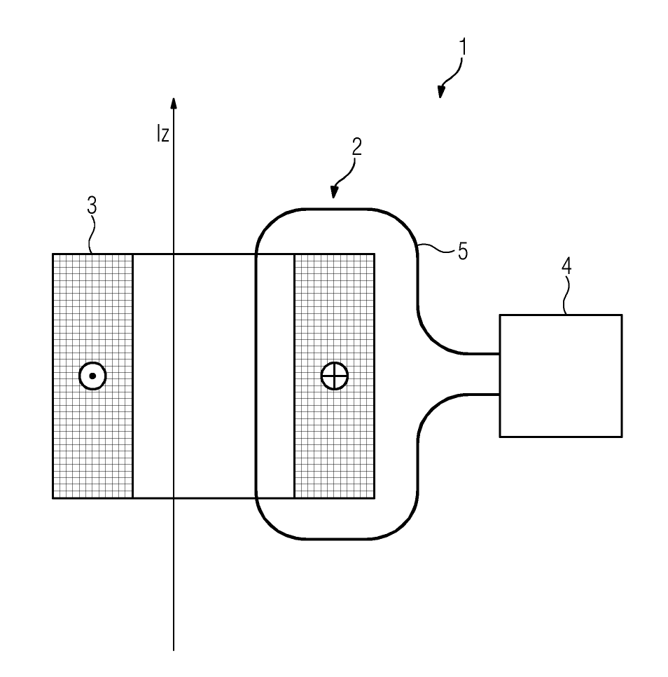

The invention relates to a device for suppressing high-frequency currents in feed lines of a converter having a common-mode inductor with a magnetic core, which is arranged to inductively couple the feed lines.

A device of this type is already known from DE 197 14 977 B4, for example. That document describes a common-mode inductor, with which high-frequency current components in feed lines of a converter can be suppressed. The common-mode inductor has a magnetic core which is coupled to winding sections of the common-mode inductor. The winding sections are connected in series in the feed lines of the converter.

For reasons of efficiency, modern converters also work with shorter and shorter switching times. This results in high rates of voltage rise, which in turn cause a wider and wider spectrum of high-frequency currents in the connection lines of the converter. High-frequency currents of this type interact, by means of capacitive and magnetic coupling or in the form of electromagnetic emission, with other devices, the function of which can be disrupted as a result.

In order to suppress high-frequency currents of this type, an inductance, for example in the form of an inductor, can be connected in series in the connection lines. The inductor has a frequency-dependent impedance and so high losses are introduced in the case of high-frequency currents. However, in order to provide damping which is as effective as possible, the inductors or coils must not enter saturation. However, this increases the demand and construction outlay which are placed on inductors of this type. This particularly concerns phase inductors, which must be designed for the whole phase current, that is to say for both the fundamental and harmonic components. Therefore, phase inductors are generally expensive.

Furthermore, common-mode inductors are known which occupy less space than phase inductors since the fundamental component of the phase currents of the converter mutually cancel out. However, the common-mode inductor must still be designed for the remaining common-mode currents, that is to say the entire non-fundamental-frequency current component.

Moreover, common-mode inductors with fed-through ground conductors are known. In this manner, it is possible also to feed the ground conductor of the load through the core of the common-mode inductor, with the result that the low-frequency component of the common-mode currents can be conducted back to the converter along this short current path. The common-mode inductor is then only loaded by the high-frequency component of the common-mode currents and can be designed correspondingly.

The problem addressed by the invention is that of providing a device of the type mentioned at the outset in which the current loading of the common-mode inductor is minimized even further, wherein the device can be integrated into existing installations in a cost-effective and simple manner.

The invention solves this problem by means of a snubber impedance unit, which is inductively coupled to the common-mode inductor and which has a frequency-dependent impedance.

The device according to the invention is minimized in terms of its construction outlay, as the common-mode inductor is freed by means of the snubber impedance unit of all current components which are not necessary for obtaining the required filter effect. This occurs by means of the inductive coupling of the common-mode inductor and the snubber impedance unit. According to the invention, the magnetic core also serves to inductively couple the feed lines and the snubber impedance unit. This inductive coupling is achieved, for example, via a snubber winding to which the snubber impedance unit is connected as load and through which the magnetic core extends. If the snubber impedance unit has a low impedance for certain frequencies, for example a frequency range, the snubber winding is substantially short-circuited for currents with such a frequency. Therefore, currents in the feed lines of the converter having frequencies which lie in the aforesaid frequency range freely induce a countercurrent in the snubber winding, which countercurrent inhibits magnetization of the magnetic core. The common-mode inductor therefore cannot be driven to saturation by currents with such frequencies and can therefore be designed in a more cost-effective and compact manner. In other words, only those currents at which the snubber impedance unit has a high impedance are suppressed by the common-mode inductor. Any desired impedance can be set through expedient selection of the passive components of the snubber impedance unit. The construction size of the common-mode inductor can therefore be reduced for almost any desired application without having to dispense with the desired filter effect.

According to one expedient configuration of the invention, the snubber impedance unit has at least one coil and/or at least one capacitor. By means of expedient interconnection of each coil and each capacitor, the desired frequency-dependent current paths can be constructed in a simple manner. Coils and capacitors are commercially available, and so the snubber impedance unit remains cost-effective.

The snubber impedance unit expediently has a parallel resonant circuit. A parallel resonant circuit is advantageous when only a particular frequency band is to be filtered out from the feed lines by the common-mode inductor. The parallel resonant circuit has an expediently high impedance only in the range of the resonant frequency. The magnetic core of the common-mode inductor is therefore magnetized only in this range. Outside the range of the resonant frequency, the impedance of the snubber impedance unit is comparatively low, with the result that the magnetic core of the common-mode inductor is not magnetized by currents which have such a frequency and is therefore not driven to saturation.

According to a variant configuration of the invention, the snubber impedance unit is a series resonant circuit. The impedance of a series resonant circuit is at a minimum when at the resonant frequency thereof. Accordingly, the common-mode inductor is only magnetized by currents having a frequency outside the range of the natural resonance of the series resonant circuit. A snubber impedance unit of this type is particularly useful when the common-mode inductor is to be protected from certain frequency bands and when the inductor does not need to be operational within said frequency bands.

Of course, any other desired combination of passive components is possible for the design of the desired properties of the snubber impedance unit. In particular, the transmission behavior thereof, the stop band thereof and the damping of the snubber impedance unit can be set as desired with these components such as coils, capacitors or ohmic resistors.

The common-mode inductor expediently forms a winding section for each feed line, wherein the winding sections are inductively coupled together via the magnetic core. This corresponds to the conventional construction of a common-mode inductor for polyphase connection lines. The winding sections are connected in series with the feed lines.

According to a preferred configuration of the invention, the snubber impedance unit is inductively coupled to the common-mode inductor via at least one snubber impedance connection line. In this case, the snubber impedance connection line expediently forms at least one conductor loop, through which the magnetic core of the common-mode inductor extends. In this way, an inductive coupling is provided between the snubber impedance unit and the magnetic core of the common-mode inductor. According to a preferred configuration of the invention, the snubber impedance connection line is configured as a snubber winding having a plurality of winding loops.

Further expedient configurations and advantages of the invention are the subject of the following description of an exemplary embodiment of the invention with reference to the FIGURE of the drawing, in which

the FIGURE schematically illustrates an exemplary embodiment of the device according to the invention.

The FIGURE schematically shows an exemplary embodiment of the device 1 according to the invention. The device 1 has a common-mode inductor 2, of which only the magnetic core 3 is indicated. In addition to the core 3, the common-mode inductor 2 has three phase windings, which can each be connected in series in a feed line phase on the AC voltage side of a converter. The three winding sections are inductively coupled together via the magnetic core 3. As in previously known common-mode inductors, the inductive coupling of the phase windings likewise ensures that, owing to the differential mode which is produced, fundamental components are eliminated and do not magnetize the magnetic core. The windings of the smoothing inductor can correspondingly be constructed to occupy less space.

In the FIGURE, the total current flowing via the three winding sections in the feed lines is indicated schematically by a simple arrow, which is referenced with I_{z}. Furthermore, it can be seen in the FIGURE that a snubber impedance unit 4 is inductively coupled to the magnetic core 3 of the common-mode inductor 2. The snubber impedance unit 4 has a snubber impedance connection line 5 for inductive coupling, which is constructed as a winding with a loop through which the magnetic core 3 of the common-mode inductor 2 extends.

The snubber impedance unit 4 is constructed as a parallel resonant circuit and comprises a coil, to put it another way an inductance, which is connected in parallel with a capacitor. Furthermore, the snubber impedance unit 4 has ohmic resistors for damping the currents in the snubber impedance unit 4.

The parallel resonant circuit of the snubber impedance unit 4 has a Gaussian or Lorenzian impedance spectrum. The impedance of the snubber impedance unit is at a maximum at the resonant frequency of the parallel resonant circuit. On both sides of the resonant frequency, the impedance falls away symmetrically and steeply and so a frequency range with a high impedance is provided. Currents with a frequency which lies within said frequency range are suppressed by the snubber impedance unit 4. Therefore, only those currents magnetize the magnetic core 3 and can be filtered out from the feed lines of the converter by the common-mode inductor.

1-7. (canceled)

8. A device for suppressing high-frequency currents in feed lines of a converter, comprising:
a common-mode inductor with a magnetic core disposed to inductively couple the feed lines; and
a snubber impedance unit inductively coupled to said common-mode inductor and having a frequency-dependent impedance.

9. The device according to claim 8, wherein said snubber impedance unit has one or both of at least one coil or at least one capacitor.

10. The device according to claim 8, wherein said snubber impedance unit is configured to form a parallel resonant circuit.

11. The device according to claim 8, wherein said snubber impedance unit is configured to form a series resonant circuit.

12. The device according to claim 8, wherein said common-mode inductor is configured to form a winding section for each feed line and further comprises a magnetic core disposed to couple together said winding sections.

13. The device according to claim 8, which further comprises a snubber impedance connection line inductively coupling said snubber impedance unit with said common-mode inductor.

14. The device according to claim 13, wherein said snubber impedance connection line forms at least one conductor loop and wherein said common-mode inductor includes a magnetic core extending through said at least conductor loop.
